(19) United States
(12) Patent Application Publication
(10) Pub. No.: US 2008/0296795 A1
(43) Pub. Date: Dec. 4, 2008

(54) Process to create decorative pattern in engineered stone

(76) Inventor: Jocelyn M. Willis-Papi, Kingston (CA)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/150,507

(22) Filed: Apr. 29, 2008

Related U.S. Application Data
(60) Provisional application No. 60/928,126, filed on May 8, 2007.

(51) Int. Cl. B29C 43/26

(52) U.S. Cl. 264/102

(57) ABSTRACT

A pattern is created in an engineered stone by creating a void in an initial mineral particle/binder composition prior to curing and solidification of the binder. The void is filled with a separate mineral/binder composition and cured at the same time as the initial composition.

### BACKGROUND OF THE INVENTION

1. Field of Invention

This invention is directed to a process for creating a decorative pattern in engineered stone materials.

2. Description of the Related Art

Engineered stone products may be produced by a well known procedure commercialized by Breton S.p.A. of Castello di Godego, Italy, so-called “Breton Stone”. In this technology, resin precursors are blended at low weight percentages with crushed stone aggregate to provide a relatively dry mass of material, distributed evenly on a support carrier, vibro-compacted under vacuum and then cured to yield a rigid product. A process used to practice this technology is disclosed by Toncelli in U.S. Pat. No. 4,698,010. Breton Stone materials are disclosed for use as flooring tile. Subsequent improvements to the technology, such as U.S. Pat. No. 6,387,985 to Wilkinson and Burchfield increased the uses of the material for general surfacing, particularly making it suitable for use as a countertop. Zodiaq® Quartz Surfacing from DuPont is an example of a commercially available engineered stone. Whether the product is floor tile or countertop, the slab produced by the Breton Stone process requires calibration to render it planar and uniform in thickness, as well as to reveal the aesthetic features of the product. This is followed by polishing to render the surface glossy.

As described in U.S. Pat. No. 6,387,985, materials may be added for a decorative effect. Decorative additives are distinguished from stone fillers primarily by the amount present in the composition. The crushed natural stone filler acts as an aggregate and is typically present in a range from 85% to 95% by weight. Decorative additives such as gemstones, metal flake or filings, micas, seashells, pearls, colored or transparent polymeric particles, mirrored particles and pigments have been added in attempts to increase the visual appeal and aesthetic qualities of the engineered stone. However, these quantities typically have not exceeded about 5% by weight, and preferably, do not exceed 2% by weight. The decorative additives are thoroughly mixed with the other components during the blending, or placed on the surface subsequent to distribution on the support carrier and prior to vibro-compaction.

### SUMMARY OF THE INVENTION

The present invention represent an improvement to a prior art process directed to formation of engineered stone containing naturally occurring mineral particles and a binder. The prior art process comprises the steps of (a) combining mineral particles with a binder to form a homogenous mixture to create a three dimensional shape, (b) employing a vacuum to remove air from the homogenous mixture of mineral particles and binder, (c) compressing and vibrating the mineral particles and binder and (d) solidifying the binder to form a solid article.

The present invention introduces the improvement in step (a) of additional steps directed to (i) forming at least one void in the three dimensional shape containing the homogenous mixture of mineral particles and binder and (ii) inserting into the void a composition containing mineral particles and binder which is not identical with the homogenous mixture whereby step (d) also results in solidification of the binder inserted into the void.

### DETAILED DESCRIPTION OF THE PREFERRED EMBODIMENTS

Engineered stone is well known in the art and is specific to a naturally occurring mineral in combination with a binder and other additives. Typically the engineered stone contains 85 to 95% by weight mineral particles and the remainder binder (on a basis of mineral particles and binder). The engineered stone is normally manufactured in the form of a slab.

A preferred mineral is quartz. A preferred binder comprises polyester which typically prior to polymerization contains coupling agent and catalyst. Examples of suitable polyesters are described in U.S. Pat. No. 3,278,662 and U.S. Pat. No. 5,321,055. Also an acrylic binder can be employed such as disclosed in U.S. Pat. No. 6,387,985.

The process steps in the present invention directly follow the prior art. An initial step combines mineral particles with a binder to form a homogenous mixture in creating a three dimensional shape. However, the present invention employs additional steps before a further step in a prior art process of employing a vacuum to remove air from the homogenous mixture of mineral particles and binder.

These additional steps are directed to forming at least one and preferably many voids in the three dimensional shape. These voids are for the purpose of creating a decorative pattern. The voids are filled with mineral particles and binder which can be identical or differ from the initial homogenous mixture. However if identical, an additional additive such as a colorant will be included. Accordingly, the two compositions will not be identical in all components.

The formation of the voids can be undertaken in two different ways. If a decorative pattern is desired to be inserted completely or substantially completely through a thickness of the three dimensional shape, a form or series of forms are present in a container having at least two fixed sides (for a continuous casting process) or all sides (for a batch process). In formation of the three dimensional shape a form is employed to create a void. The flow of an initial, i.e. first, mineral particle/binder composition is sufficient slow in the three dimensional shape such that an additional, i.e. second, mineral particle/binder composition may be inserted in a void so that a distinct decorative pattern is completely through or substantially completely through a thickness of the three dimensional shape.

The shape of the form will be determined by the decorative pattern which is desired in the final article. Illustratively if a vein to mimic the appearance of a naturally mineral such as marble the form or series of form will have an appearance to impart the random shape. If a geometric pattern is desired, a form will have a geometric shape. The composition of the form is not critical and for purpose of illustration the form can be wood or metal. The necessary property of the form is an ability to withstand pressure from the mineral particle/binder composition.

If only a surface decorative pattern is desired, then a form is placed on a surface of the initial mineral particle/binder composition to create a void followed by insertion of the additional particle/binder composition. However this manner of creating the decorative pattern is less desirable since only a surface decorative pattern is created.

After formation of the decorative pattern, the remaining process steps follow the prior art. These steps include employing a vacuum to remove air since otherwise air will be entrapped to create undesirable voids. The three dimensional shape is then compressed and vibrated followed by solidification to form a solid article which typically is in the form of a slab. It is desirable to employ the same binder for throughout the three dimensional shape in a preferred mode although such employment is not essential.

It is understood that additives may be added to the mineral particle/binder composition as is well known. Thus the components use for formation of the final article are conventional as well as the process steps other the steps to create and fill voids as described above.

The following example is provided to further illustrate the present invention.

### EXAMPLE

### Materials for First Casting Mixture

Materials for First Casting Mixture:

| Amount | | |
|---|---|---|
| 0.0871 | kg | peroxide catalyst |
| 4.292 | kg | polyester resin binder |
| 0.0654 | kg | coupling agent |
| 8.170 | kg | 6 mesh quartz aggregate |
| 10.53 | kg | 10 mesh quartz aggregate |
| 17.79 | kg | 34 mesh quartz aggregate |
| 7.08 | kg | 84 mesh quartz aggregate |
| 11.62 | kg | 325 mesh quartz aggregate |
| 0.349 | kg | pigment |

### Materials for Second Casting Mixture

Materials for Second Casting Mixture:

| Amount | | |
|---|---|---|
| 0.086 | kg | peroxide catalyst |
| 4.26 | kg | polyester resin binder |
| 0.0654 | kg | coupling agent |
| 14.34 | kg | 6 mesh quartz aggregate |
| 7.79 | kg | 10 mesh quartz aggregate |
| 15.43 | kg | 34 mesh quartz aggregate |
| 5.675 | kg | 84 mesh quartz aggregate |
| 12.0 | kg | 325 mesh quartz aggregate |
| 0.3916 | kg | pigment |

The above two casting mixtures were separately blended in a mixer set to slow speed for 60 seconds. Three wooden forms were sawn in serpentine shapes of two different sizes were placed in the center of the laydown frame. The first casting mixture was poured in the frame. The insert forms were removed from the frame to form voids in the first casting mixture. The second casting mixture was employed to fill voids in forming decorative serpentine patterns. The laydown frame with the casting mixture was conveyed to a vibro-compaction press and vibro-compacted for 95 seconds at 3400 RPM under a vacuum of 5 mbar. The laydown frame with vibro-compacted casting mixture was then conveyed to an oven to cure the mixture at 105 C for 15 minutes followed by cooling under a fan for 15 minutes.

What is claimed is:

1. In a process for formation of a solid article formed from a naturally occurring mineral by use of mineral particles and a binder comprising the steps of:
(a) combining mineral particles with a binder to form a homogenous mixture to create a three dimensional shape,
(b) employing a vacuum to remove air from the homogenous mixture of mineral particles and binder,
(c) compressing and vibrating the mineral particles and binder and
(d) solidifying the binder to form the solid article,
wherein the improvement includes in step (a):
(i) forming at least one void in the three dimensional shape containing the homogenous mixture of mineral particles and binder and;
(ii) inserting into the void a composition containing mineral particles and binder which is not identical with the homogenous mixture;
whereby step (d) also results in solidification of the binder inserted into the void.
